(19) United States
(12) Patent Application Publication
(10) Pub. No.: US 2006/0124154 A1
(43) Pub. Date: Jun. 15, 2006

(54) System and method for washing a vehicle

(75) Inventor: Michael A. Rivalto, Memphis, TN (US)

Correspondence Address: BROOKS KUSHMAN P.C., 1000 TOWN CENTER, TWENTY-SECOND FLOOR, SOUTHFIELD, MI, 48075, US

(73) Assignee: M.A. Rivalto, Inc., Memphis, TN (US)

(21) Appl. No.: 11/299,589

(22) Filed: Dec. 12, 2005

Related U.S. Application Data
(60) Provisional application No. 60/635,084, filed on Dec. 10, 2004.

(51) Int. Cl. B08B 7/04; B08B 3/00; B08B 3/12

(52) U.S. Cl. 134/18; 134/123; 134/94.1; 134/103.2; 134/103.3; 134/172; 134/34; 134/56 R

(57) ABSTRACT

A washing system configured for use in the interior storage area of a vehicle includes one or more guide rails disposed on an interior portion of the storage area of the vehicle. A washing unit is disposed in the storage area of the vehicle and is operatively connected to the one or more guide rails. The washing unit has a frame including a channel extending therethrough and one or more nozzles in communication with the channel. At least one drive mechanism is operatively connected to the one or more guide rails and the washing unit. The drive mechanism is configured to move the washing unit through the storage area of the vehicle. A washing supply unit in communication with the washing unit directs a washing solution under pressure to the washing unit that is expelled through the one or more nozzles on to the storage area of the vehicle.

### CROSS-REFERENCE TO RELATED APPLICATIONS

This application claims the benefit of U.S. provisional application Ser. No. 60/635,084, filed Dec. 10, 2004.

### BACKGROUND OF THE INVENTION

1. Field of the Invention

The present invention relates to a washing system for a vehicle, and more particularly, to a washing system incorporated into the structure of a tractor trailer.

2. Background Art

Tractor or truck trailers are designed to haul significant quantities or large item freight between various locations. The conventional enclosed tractor trailer comprises a bed, a pair of sidewalls extending from the bed toward a trailer roof, a front wall and a rear wall, all cooperating to define a storage area therebetween.

Most trailers typically include openings formed in the rear or sidewalls or the trailer body covered by sliding or pivoting doors allowing access to the storage area. A forward locking portion of the trailer is secured to a hitch on the rear portion of the tractor truck. It is common for trailer storage areas to include heating and cooling systems extending through the storage area to maintain a desired temperature within the storage area for transportation of perishable goods between locations.

Federal and State shipping regulations require that the storage areas of tractor trailers be cleaned after goods have been shipped to their final destination. Many trailer owners hire manual laborers to cleanse the interior storage compartment of their trailers. These resources come at a great expense to the trailer owner and frequently rely on the availability of manual labor in the shipping area. Alternatively, some shipping and loading docks may include trailer interior washing systems to assist the trailer owner in the cleaning process.

Conventional interior trailer washing systems generally comprise a washing head mounted on one end of an extendable horizontal boom which travels the length of the storage compartment. Alternatively, a robotic cleaning vehicle may be inserted into the storage compartment to perform the cleaning operation. Both systems require fixed resources to support these cleaning systems and are not flexible enough to easily transport to remote locations.

It would be advantageous to provide an interior washing system for a tractor trailer which could be easily transported between locations. It would be further advantageous to provide an automated washing system mounted within the storage compartment or area of the trailer to perform the cleaning process. It would also be advantageous to provide a washing system for a vehicle such as a tractor trailer mountable on the vehicle and cleanses the exterior of the vehicle after transportation of goods between locations.

### SUMMARY OF THE INVENTION

The present invention provides a washing system configured for use in the interior storage area of a vehicle. The washing system includes one or more guide rails disposed on an interior portion of the storage area of the vehicle. A washing unit is disposed in the storage area of the vehicle and is operatively connected to the one or more guide rails. The washing unit has a frame including a channel extending therethrough and one or more nozzles in communication with the channel.

At least one drive mechanism is operatively connected to the one or more guide rails and the washing unit. The drive mechanism is configured to move the washing unit through the storage area of the vehicle. A washing supply unit in communication with the washing unit directs a washing solution under pressure to the washing unit that is expelled through the one or more nozzles on to the storage area of the vehicle.

A controller is in communication with the washing unit, at least one drive mechanism and washing supply unit. The controller instructs the washing supply unit to direct a washing solution under pressure to the washing unit that is expelled through the one or more nozzles on to the storage area of the vehicle as the at least one drive mechanism moves the washing unit through the storage area of the vehicle.

In another aspect of the present invention, the trailer washing system comprises a first washing unit configured for use in an interior portion of a trailer and a second washing unit configured for use on an exterior portion of a trailer. The first washing unit includes a frame having a channel extending therethrough and a plurality of nozzles disposed about the periphery of the frame in communication with the channel. At least one drive mechanism is operatively connected one or more guide rails extending through the interior of the trailer and the first washing unit to move the first washing unit through the interior storage area of the trailer.

The second washing unit includes a frame having a channel extending therethrough and one or more nozzles disposed about the periphery of the frame in communication with the channel. At least one drive mechanism is operatively connected to one or more rails provided on the exterior of the trailer and the second washing unit to move the second washing unit about the exterior of the trailer. A washing supply unit is in communication with the first and second washing units and directs a washing solution under pressure to the first and second washing units that is expelled through the nozzles on to the interior storage area and exterior of the trailer.

A controller is in communication with the first and second washing units and the washing supply unit. The controller instructs the washing supply unit to direct a washing solution under pressure to the first washing unit that is expelled through the one or more nozzles on to the storage area of the trailer vehicle as the at least one drive mechanism moves the first washing unit through the storage area of the vehicle and onto the exterior of the trailer as the at least one drive mechanism moves the second washing unit about the exterior of the trailer.

Other features and advantages of the present invention will be readily appreciated and better understood after reading the subsequent description when considered in connection with the accompanying drawings.

### BRIEF DESCRIPTION OF THE DRAWINGS

FIG. 1 is a side elevational view of a tractor and tractor trailer arrangement incorporating one aspect of the trailer washing system of the present invention;

FIG. 2 is a cross-sectional view of the tractor trailer and trailer washing system along line 2-2 of FIG. 1;

FIG. 3 is a fragmentary side elevational view of the trailer washing system in a trailer in accordance with the present invention;

FIG. 4 is a rear elevational view of the trailer washing system drive mechanism and track mounted within the storage area of the trailer;

FIG. 5 is a side elevational view of the drive mechanism of the trailer washing system;

FIG. 6 is a rear elevational view of the spray nozzles of the trailer washing system cleaning the storage area of the trailer;

FIG. 7 is a side elevational view of the trailer washing system stored in the trailer in accordance with one aspect of the present invention;

FIG. 8 is a side elevational view of the trailer washing system stored in the trailer in accordance with another aspect of the present invention; and

FIG. 9 is a side elevational view of a tractor and tractor trailer arrangement incorporating an interior and exterior trailer washing system in accordance with another aspect of the present invention.

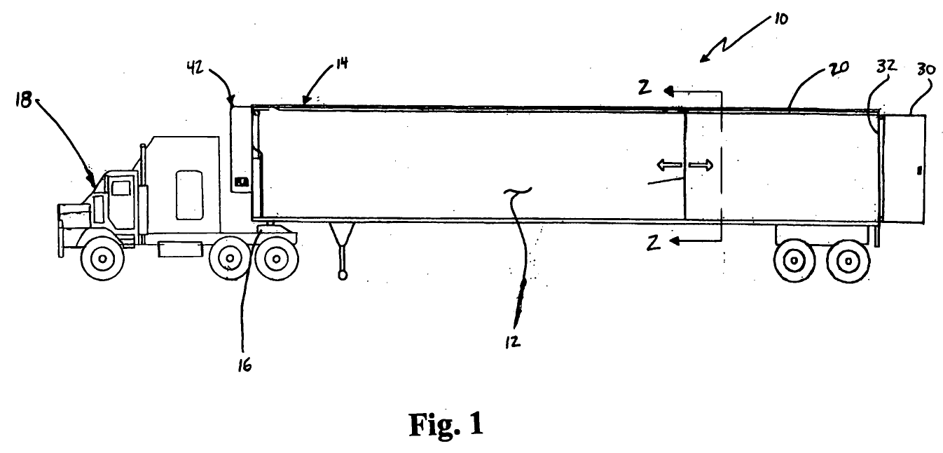

### DETAILED DESCRIPTION OF THE PREFERRED EMBODIMENT(S)

Referring now to the Figures, a trailer washing system 10 configurable for use with a motor vehicle, motor vehicle accessory and/or vehicle storage container or area is disclosed and claimed herein. Trailer washing system 10 is designed for use with a tractor trailer removably connected to a tractor truck. However, it is understood that the washing system could be used with a variety of motor vehicles, including cars and vans, as well as freight containers commonly used in the shipping industry. Further description of the washing system of the present invention is provided below.

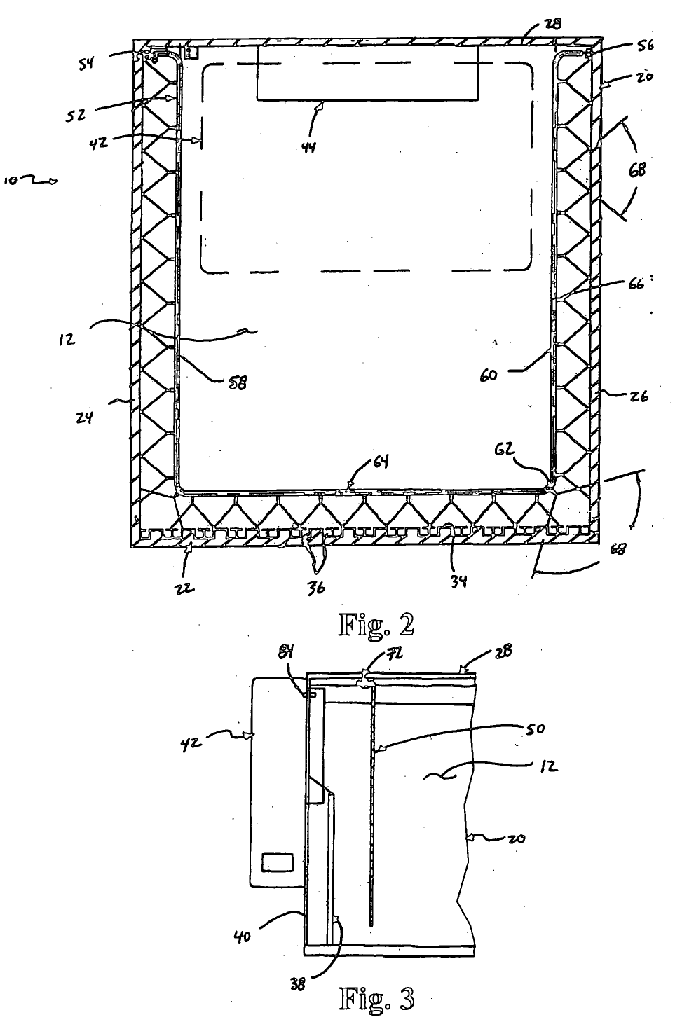

In a first aspect of the present invention, trailer washing system 10 is configured for use in the interior storage area 12 or inner body of the tractor trailer 14. Tractor trailer 14 is coupled to a hitch 16 on the rear portion of a truck tractor 18 to be transported between locations. Referring additionally to FIG. 2, trailer 14 includes an exterior body 20 having a base 22, a pair of generally vertical sidewalls 24, 26, extending upward from the base and a roof 28 secured to sidewalls 24, 26. Storage area 12 is defined between base 22, sidewalls 24, 26 and roof 28.

One or more doors 30 are mounted adjacent an opening in loading area 32 provided in the rear portion of the trailer body 20. Doors 30 secure opening 32, providing convenient access for the loading and unloading of goods into storage area 12. It is understood that opening 32 may be provided in a variety of locations on the trailer body, including in one or more of the sidewalls 24, 26. Further, doors 30 may be pivotally or slidably mounted to the trailer body 20 to enclose the goods stored within storage compartment or area 12.

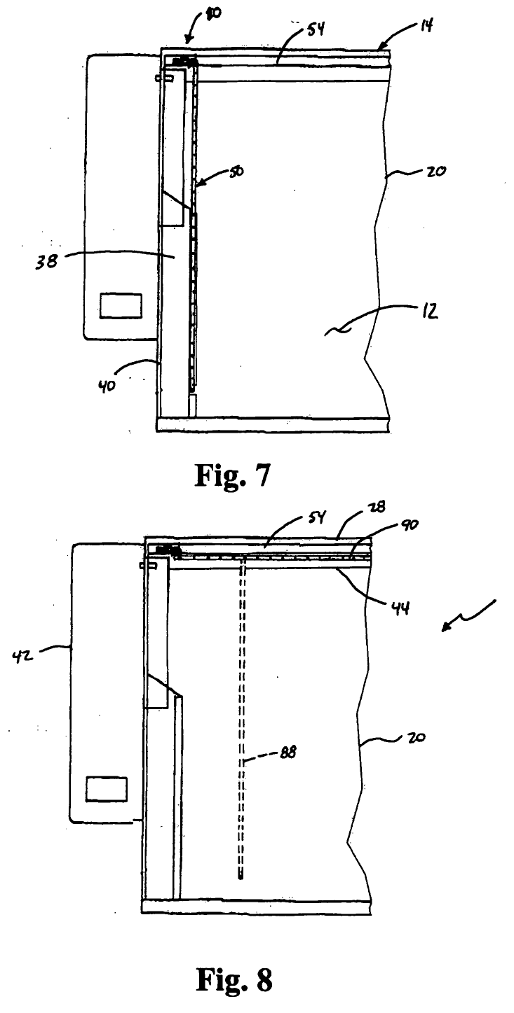

Referring additionally to FIG. 6, a flooring structure 34 for supporting cargo in storage area 12 is placed along an upper surface of trailer base 22. The flooring structure typically is formed of a series of channels 36 allowing drainage of material from the storage area to the exterior of the trailer body 20.

Referring now to FIGS. 2-3, trailer 14 includes a front bulkhead 38 disposed on a front portion of trailer body 20. Front bulkhead 38 protects the forward wall 40 of the trailer body 20 from cargo susceptible to shifting during transport. In one embodiment of the present invention, trailer 14 includes a cooling unit 42 mounted to an exterior portion of the forward wall 40 of trailer body 20.

Cooling unit 42 cooperates with overhead ducts 44 extending at least partially through the storage area 12 along a lower surface of roof 28. Ducts 44 supply conditioned air from the cooling unit 42 to all portions of the storage area 12, allowing transportation of temperature sensitive cargo within trailer 14. It is understood that the washing system can be used with trailers either having or removing the cooling units and ducts, as well any of a variety of stand alone storage containers.

Referring now to FIGS. 2 and 4-6, trailer washing system 10 includes a washing apparatus 50 disposed within the storage area 12 of the trailer 14. Washing apparatus 50 includes a controller, a washing unit 52 rotatably mounted to a pair of guide rails 54, 56 disposed on interior portions of sidewalls 24, 26. It is understood that rails 54, 56 may be positioned on a variety of surfaces based on storage area space limitations. For example, guide rails 54, 56 may be disposed on the lower surface of roof 28 to accommodate ducting for cooling unit 42. Alternatively, a single rail may be used to support washing unit 52.

Washing unit 52 includes a pair of transversely spaced vertical members 58, 60 connected at a lower end 62 to a generally horizontal member 64 extending therebetween. Each of the washing unit members 58, 60, 64, are generally formed of stainless steel tubing and include a passage (not shown) formed therethrough which receives pressurized air and fluid. Washing unit 52 can be formed as a unitary structure, or alternatively, formed from a number of tubing pieces. Various geometries of tubing and types of materials, including polymers such as polypropylene or metals such as aluminum, may be used to accomplish the same result.

A plurality of nozzles 66 are formed on the outer periphery of washing unit 52, discharging either air or a fluid washing solution 68 onto the interior walls of the storage area 12. As is shown in the Figures, nozzles 66 discharge solution 68 in angled fanned patterns. It is understood that the exhaust ports of the nozzles may be adjusted to provide various discharge patterns based on trailer cleaning requirements. In one aspect of the present invention, guide rails 54, 56, are formed as U-shaped channel 70 receiving at least one drive mechanism 72 of washing unit 52. Guide rails 54, 56 extend the length of the storage area 12 of trailer 14, allowing washing unit 52 to travel bidirectionally between the forward and rear portions of the trailer body 20. It is understood that a variety of rail geometries may be used to perform the same function.

As is shown best in FIG. 5, each end of the washing unit 52 includes a drive mechanism 72. It is also contemplated that a single drive mechanism may be used to drive both ends of the washing unit. Drive mechanism 72 includes a drive motor 74 operatively connected to at least one wheel 76. In a preferred aspect of the invention, wheel 76 cooperates with a pair of guide wheels 78, 80 rotatably mounted to frame 82 of washing unit 52. Drive motor 74 rotates drive wheel 76, causing wheels 78, 80 to move through channel 70 of guide rails 54, 56, to translate washing unit 52 forward and rearward through the storage area 12.

Drive motor 74 is preferably bidirectional allowing forward and rearward travel of the washing unit 52 on rails 54, 56. It is understood that other drive arrangements may be used to move the washing unit along the guide rails. For example, single direction motors may be placed on both ends of the washing unit, such that one motor is responsible for forward movement of the washing unit and the other handles rearward movement of the washing unit through the storage area.

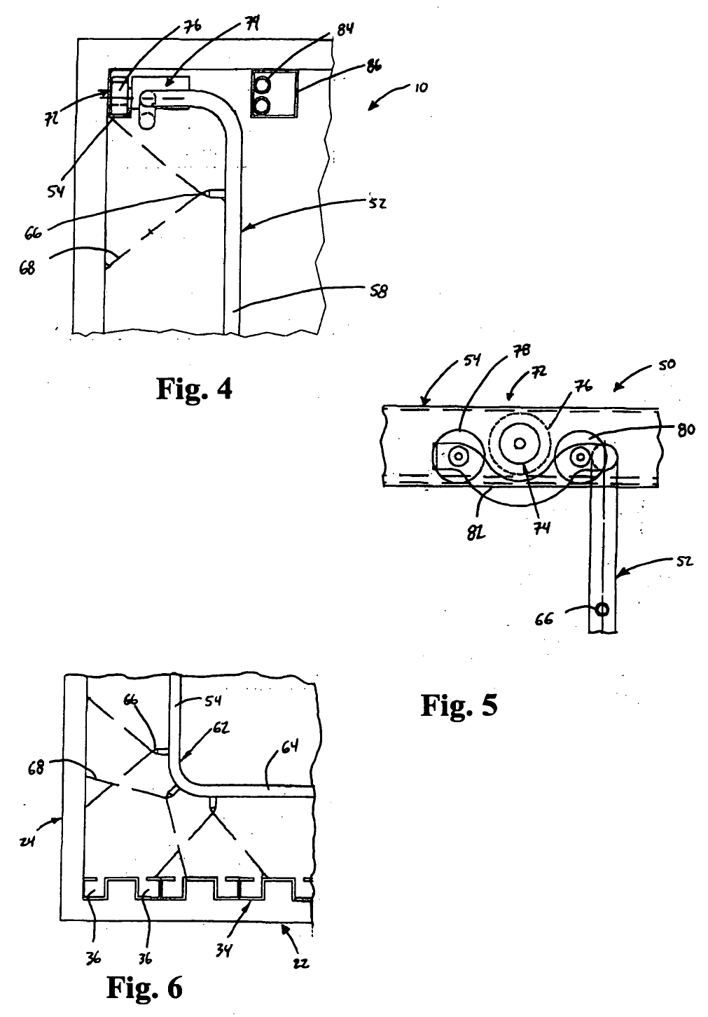

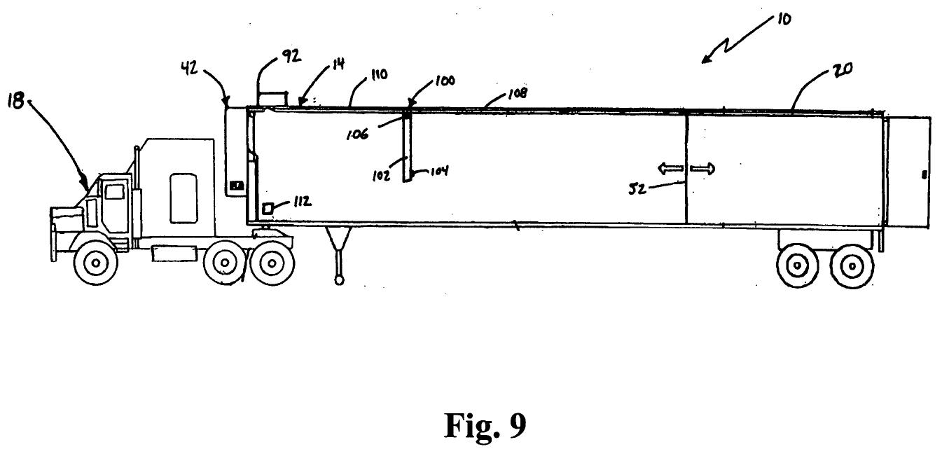

Referring now to FIGS. 3 and 4, one or more hose lines 84 extend from the front wall 40 of the trailer 14 to the washing unit 52 through a covered tray 86. Hose lines 84 supply various products to washing apparatus 50 to complete the washing process. For example, hose lines may transport pressurized air, water and cleaning solution from a washing supply unit 92 shown in FIG. 9 mounted on the trailer or tractor to the washing unit 52 to be expelled through nozzles 66. A description of the washing unit cleaning process will be discussed in greater detail below.

Referring now to FIG. 7, a first storage arrangement for the washing apparatus 50 in the storage area 12 of trailer 14 is illustrated. The front bulkhead 38 of trailer 14 is configured to receive the washing unit 52 of trailer washing apparatus 50 when the unit 52 is positioned in a stored position on rails 54 adjacent the forward wall 40 of trailer body 20. Placement of washing apparatus 50 adjacent the forward wall 40 maximizes storage space in storage area 12 while protecting the washing apparatus 50 from items shifting during transport.

In an alternative storage arrangement shown in FIG. 8, washing apparatus of washing system 10 is pivotally mounted to guide rails 54 and is movable between a deployed or use position as noted by reference number 88 and a stored position 90. The washing apparatus is pivoted upward about guide rails to place the apparatus in a generally planar relationship with the roof 28 of trailer body 20. If the storage compartment or trailer 14 includes a cooling unit 42, channels may be provided in ducts 44 to accommodate the washing apparatus 90 while protecting the unit from damage.

Referring now to FIG. 9, another aspect of the present invention is illustrated and described. Trailer washing system 10 includes an exterior washing unit 100 disposed on an exterior body 20 of trailer 14 hitched to tractor 18. It is contemplated that the exterior or second washing unit 100 may be configured in a number of fashions or locations about the exterior of the vehicle and may be integrated into the trailer body or removably mounted thereto. One preferred aspect of the invention is described below.

The second washing unit 100 includes a frame 102 having a channel (not shown) extending therethrough similar to that described for the washing unit 50 above. Frame 102 includes one or more nozzles 104 disposed about the periphery of the frame 102 in communication with the channel. At least one drive mechanism 106 is operatively connected to one or more rails 108 provided on the exterior 20 of the trailer and the second washing unit 100 to move the second washing unit 100 about the exterior 20 of the trailer.

Washing supply unit 92 is provided on a top portion 110 of the exterior body 20 of trailer 10 adjacent cooling unit 42. The washing supply unit 92 is in communication with the first washing unit 52 and the second washing unit 100. It is contemplated that the washing supply unit may be disposed on another portion of the trailer. Alternatively, the washing system of the present invention may also use external resources to complete the cleaning operation.

For example, the washing apparatus may be coupled to a portable generator, fixed power supply or compressor to power the drive mechanism and compressor. Further, an external water or air supply may be connected to the trailer washing apparatus to provide the materials necessary to complete the cleaning operation. It is also contemplated that the cooling unit coupled to the trailer may supply both power and compressed air to the washing apparatus.

Controller 112 is in communication with the first and second washing units 52, 100 and washing supply unit 92. Controller 112 instructs the washing supply unit 92 to direct a washing solution under pressure to the first and second washing units 52, 100 that is expelled through the one or more nozzles on to the interior storage area 12 of the trailer 14 as the at least one drive mechanism moves the washing unit 52 through the storage area 12 and onto the exterior body 20 of the trailer 14 as the at least one drive mechanism moves the second washing unit 100 about the exterior of the trailer 14.

The method of cleaning the storage area of the trailer using the washing system in accordance with the present invention is described in greater detail. A user activates and controls the washing apparatus using a controller coupled to the trailer. Controller is coupled to a power supply provided on the trailer which powers the washing apparatus. Controller activates the drive mechanism of washing unit to move the washing unit from the stored position to a use position. In a preferred aspect of the invention, washing unit performs a four cycle cleaning operation. However, it is understood that the cleaning operation may be completed using any number of cycles depending on the conditions of the storage area.

In the first cycle of the cleaning operation, washing unit is driven from the forward portion of the trailer to the rear portion of the trailer along the guide rails. During this cycle, pressurized air is forced through supply hoses into the passages formed through the structural members of the washing unit. The pressurized air is expelled through nozzles cooperating with the passages in washing unit to loosen dirt and other particulate from the storage area in trailer towards the opening in the rear portion of the trailer. It is understood that the pressurized air is expelled through the nozzles at an optimal psi (pounds per square inch) to loosen particulate from the trailer floor.

In the second cycle of the cleaning operation, the controller instructs drive mechanism of the washing apparatus moves the washing unit along the guide rails from the rear portion of the trailer to the forward portion of the trailer. A fluid cleaning solution stored in a container mounted on the trailer is supplied to washing unit through the supply hoses. The roof, sidewalls and floor of the trailer body are coated with the cleaning solution as the washing unit travels to the front of the trailer.

In the third cycle of the cleaning operation, the controller instructs the washing apparatus drive mechanism to move the washing unit from the forward portion of the trailer toward the rear portion of the trailer while expelling water stored in a container on the trailer through the nozzles. The pressurized water removes the cleaning solution from the interior surfaces of the trailer body and drains through the channels provided in the floor of the trailer. In the fourth cycle of the cleaning operation, the controller instructs the drive mechanism to move the washing unit back to the storage position at the front portion of the trailer in the final cycle of the cleaning operation.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A washing system configured for use in the interior storage area of a vehicle, the washing system comprising:
one or more guide rails disposed on an interior portion of the storage area of the vehicle;
a washing unit disposed in the storage area of the vehicle operatively connected to the one or more guide rails, the washing unit having a frame including a channel extending therethrough and one or more nozzles in communication with the channel;
at least one drive mechanism movably connected to the one or more guide rails and the washing unit configured to move the washing unit through the storage area of the vehicle;
a washing supply unit in communication with the washing unit; and
a controller in communication with the washing unit, at least one drive mechanism and washing supply unit,
wherein the controller instructs the washing supply unit to direct a washing solution under pressure to the washing unit that is expelled through the one or more nozzles on to the storage area of the vehicle as the at least one drive mechanism moves the washing unit through the storage area of the vehicle.

2. The washing system of claim 1 wherein the washing system is configured for use in the interior storage area of a tractor trailer.

3. The washing system of claim 2 wherein the washing unit is positionable between a deployed position and a stored position wherein the washing unit is positioned in a front bulkhead disposed on a front portion of the trailer body.

4. The washing system of claim 2 further comprising a cooling unit mounted to a portion of the trailer body, wherein the cooling unit is a power source in communication with the washing, at least one drive mechanism and washing supply unit.

5. The washing system of claim 1 wherein the one or more guide rails further comprises a pair of guide rails disposed on opposing walls of the storage area and extending the length of the storage area.

6. The washing system of claim 1 wherein the one or more guide rails further comprises a single guide rails disposed on a top surface of the storage area and extending the length of the storage area.

7. The washing system of claim 1 wherein the frame of the washing unit comprises a pair of transversely spaced vertical members and a generally horizontal member extending therebetween.

8. The washing system of claim 1 wherein the one or more drive mechanism further comprises a motor in communication with at least one drive wheel configured for use with one or more guide rails.

9. The washing system of claim 8 wherein the motor of the at least one drive mechanism allows the washing unit to travel bidirectionally along the one or more rails in the storage area.

10. The washing system of claim 8 further comprising motors disposed at each end of the one or more rails allowing the washing unit to travel unidirectionally along the one or more rails in the storage area.

11. The washing system of claim 1 wherein the washing unit further comprises a plurality of nozzles formed on the outer periphery of washing unit.

12. The washing system of claim 1 wherein the washing supply unit is disposed on the vehicle and includes a pressurized air source and a washing solution container.

13. A trailer washing system comprising:
a first washing unit configured for use along one or more guide rails disposed in the interior storage area of the trailer, the washing unit having a frame including a channel extending therethrough, a plurality of nozzles disposed about the periphery of the frame in communication with the channel and at least one drive mechanism operatively connected to the one or more guide rails and the first washing unit to move the first washing unit through the interior storage area of the trailer;
a second washing unit configured for use on one or more rails extending about an exterior surface of the tractor trailer, the second washing unit including a frame having a channel extending therethrough, one or more nozzles disposed about the periphery of the frame in communication with the channel and at least one drive mechanism operatively connected to the one or more rails and the second washing unit to move the second washing unit about the exterior of the trailer;
a washing supply unit in communication with the fist and second washing units; and
a controller in communication with the first and second washing units and the washing supply unit,
wherein the controller instructs the washing supply unit to direct a washing solution under pressure to the first and second washing units that is expelled through the one or more nozzles on to the storage area of the trailer as the at least one drive mechanism moves the first washing unit through the storage area of the vehicle and onto the exterior of the trailer as the at least one drive mechanism moves the second washing unit about the exterior of the trailer.

14. The trailer washing system of claim 13 wherein the first washing unit is positionable between a deployed position and a stored position wherein the washing unit is positioned in a front bulkhead disposed on a front portion of the trailer body.

15. The trailer washing system of claim 13 further comprising a cooling unit mounted to a portion of the trailer body, wherein the cooling unit is a power source in communication with the first and second washing units and the washing supply unit.

16. The trailer washing system of claim 13 wherein the at least one drive mechanism of the first drive mechanism includes a motor which allows the washing unit to travel bidirectionally along the one or more rails in the trailer storage area.

17. The trailer washing system of claim 13 wherein the at least one drive mechanism of the first drive mechanism further comprises motors disposed at each end of the one or more rails allowing the first washing unit to travel unidirectionally along the one or more rails in the trailer storage area.

18. A method for cleaning an interior storage area of a vehicle using an integrated washing system comprises:
providing a washing unit configured for use along one or more guide rails disposed in the interior storage area of the trailer, the washing unit having a frame including a channel extending therethrough, a plurality of nozzles disposed about the periphery of the frame in communication with the channel;
providing a washing supply unit in communication with the washing unit;
instructing at least one drive mechanism operatively connected to the one or more guide rails and the first washing unit with a controller to move the first washing unit through the interior storage area of the trailer to begin at least one washing cycle;
instructing the washing supply unit with the controller to direct a washing solution under pressure to the washing unit that is expelled through the one or more nozzles of the washing unit on to the storage area of the trailer; and
instructing the washing unit and washing supply unit with the controller to cease operation upon completion of the at least one washing cycle.

19. The method of claim 18 further comprising the step of:
instructing the at least one drive mechanism to move the washing unit from a stored position wherein the washing unit is positioned in a front bulkhead disposed on a front portion of the trailer body to a deployed position upon activation of a washing cycle and to return the washing unit upon completion of the at least one washing cycle.

20. The method of claim 18 wherein the step of instructing the at least one drive mechanism to complete at least one washing cycle further comprises instructing the at least one drive mechanism, washing unit and the washing supply unit with the controller to complete four washing cycles.
